(19) United States
(12) Patent Application Publication
(10) Pub. No.: US 2007/0074067 A1
(43) Pub. Date: Mar. 29, 2007

(54) Maintaining memory reliability

(76) Inventors: Michael A. Rothman, Puyallup, WA (US); Vincent J. Zimmer, Federal Way, WA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/238,769

(22) Filed: Sep. 29, 2005

(51) Int. Cl. G06F 11/00

(52) U.S. Cl. 714/6

(57) ABSTRACT

A hardware error monitor of a computer system is initialized. A memory module error in a memory module of the computer system is detected by the hardware error monitor. The memory module is logically removed from the computer system in response to the memory module error.

### TECHNICAL FIELD

Embodiments of the invention relate to the field of computer systems and more specifically, but not exclusively, to maintaining memory reliability.

### BACKGROUND

Reliable memory is important to the functioning of computer systems. Faulty memory modules may lead to data loss as well as a system crash. The frequency of memory errors in modern systems has been rising due to increased memory data rates, increased memory densities, and increased memory thermal effects.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a diagram illustrating a virtualization environment in accordance with an embodiment of the invention.

FIG. 2 is a flowchart illustrating the logic and operations of maintaining memory reliability in accordance with an embodiment of the invention.

FIG. 3 is a flowchart illustrating the logic and operations of maintaining memory reliability in accordance with an embodiment of the invention.

FIG. 4 is a flowchart illustrating the logic and operations of maintaining memory reliability in accordance with an embodiment of the invention.

FIG. 5 is a diagram illustrating one embodiment of a system for implementing embodiments of the invention.

### DETAILED DESCRIPTION

In the following description, numerous specific details are set forth to provide a thorough understanding of embodiments of the invention. One skilled in the relevant art will recognize, however, that embodiments of the invention can be practiced without one or more of the specific details, or with other methods, components, materials, etc. In other instances, well-known structures, materials, or operations are not shown or described in detail to avoid obscuring understanding of this description.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the following description and claims, the term “coupled” and its derivatives may be used. “Coupled” may mean that two or more elements are in direct contact (physically, electrically, magnetically, optically, etc.). “Coupled” may also mean two or more elements are not in direct contact with each other, but still cooperate or interact with each other.

Embodiments of the invention provide improved memory reliability. If a memory module exceeds a memory error threshold, then that memory module is “logically” removed from the system without rebooting the system. However, the memory module may still physically reside in a memory module slot. In one embodiment, a virtualization environment is used to logically remove the faulty memory module.

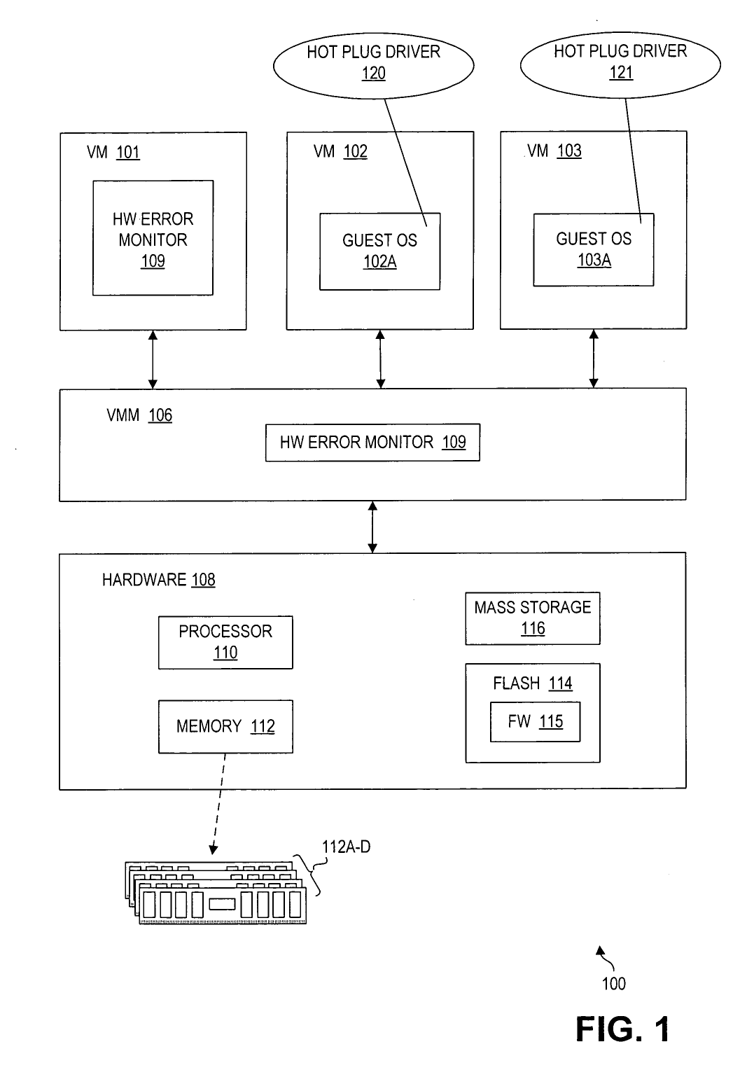

Referring to FIG. 1, a computer system 100 in accordance with one embodiment of the invention is shown. Computer system 100 includes a Virtual Machine Monitor (VMM) 106 layered on physical hardware 108. VMM 106 supports Virtual Machines (VMs) 101, 102 and 103. In one embodiment, computer system 100 is a server.

A Virtual Machine (VM) is a software construct that behaves like a complete physical machine. A VM includes virtual versions of physical machine components, such as a virtual processor(s), virtual memory, a virtual disk drive, or the like. Each VM may support a Guest Operating System (OS) and associated applications.

A Virtual Machine Monitor gives each VM the illusion that the VM is the only physical machine running on the hardware. The VMM is a layer between the VMs and the physical hardware to maintain safe and transparent interactions between the VMs and the physical hardware. Each VM session is a separate entity that is isolated from other VMs by the VMM. If one VM crashes or otherwise becomes unstable, the other VMs, as well as the VMM, should not be adversely affected.

In one embodiment, firmware (FW) instructions 115 for implementing VMM 106 are stored in Flash memory 114 and are loaded during the preboot phase of computer system 100. The preboot phase occurs between power-on (reset) and the successful load of a Guest operating system. The lifespan of a Guest OS is the OS runtime of that Guest OS.

VM 102 executes a Guest OS 102A, and VM 103 executes a Guest OS 103A. While embodiments herein are described using Guest OSs, it will be understood that alternative embodiments may include other guests, such as a System Management Mode (SMM), running in a VM. In one embodiment, Guest OS 102A includes a hot plug driver 120 and Guest OS 103A includes a hot plug driver 121 (described further below).

In one embodiment, VM 101 executes a hardware (HW) error monitor 109. In an alternative embodiment, hardware error monitor 109 may be implemented as a part of VMM 106.

In one embodiment, VMM 106 and/or VMs 101-103 operate substantially in compliance with the Extensible Firmware Interface (EFI) (Extensible Firmware Interface Specification, Version 1.10, Dec. 1, 2002, available at http://developer.intel.com/technology/efi). EFI enables firmware, in the form of firmware modules, such as drivers, to be loaded from a variety of different resources, including flash memory devices, option ROMs (Read-Only Memory), other storage devices, such as hard disks, CD-ROM (Compact Disk-Read Only Memory), or from one or more computer systems over a computer network. One embodiment of an implementation of the EFI specification is described in the Intel® Platform Innovation Framework for EFI Architecture Specification—Draft for Review, Version 0.9, Sep. 16, 2003, referred to hereafter as the “Framework” (available at www.intel.com/technology/framework). It will be understood that embodiments of the present invention are not limited to the “Framework” or implementations in compliance with the EFI specification.

Hardware 108 includes a processor 110, memory 112, mass storage 116, and Flash memory 114. In the embodiment of FIG. 1, memory 112 includes four memory modules 112A-D, respectively. Embodiments of a memory module include a Dual In-line Memory Module (DIMM), a Single In-line Memory Module (SIMM), or the like. It will be understood that while embodiments of the invention are described herein using four memory modules 112A-D, embodiments of the invention may be implemented using alternative numbers of memory modules.

In one embodiment, processor 110 includes architecture in accordance with an Intel® Virtualization Technology (VT). Intel® VT extends the virtualization environment to processor hardware instead of virtualization being exclusively a software implementation. A processor with Intel® VT allows Guest OSs and applications to execute in the processor privilege rings (e.g., ring-0 to ring-3) as the software was originally designed while allowing the VMM to maintain strict control over system critical functions, such as memory mapping. Further, transactions between the VMM are the Guest OSs are supported at the processor hardware layer to speed up such interactions. Also, processor state information for the VMM and the Guest OSs is maintained in dedicated address spaces to speed up transactions and maintain integrity of state information.

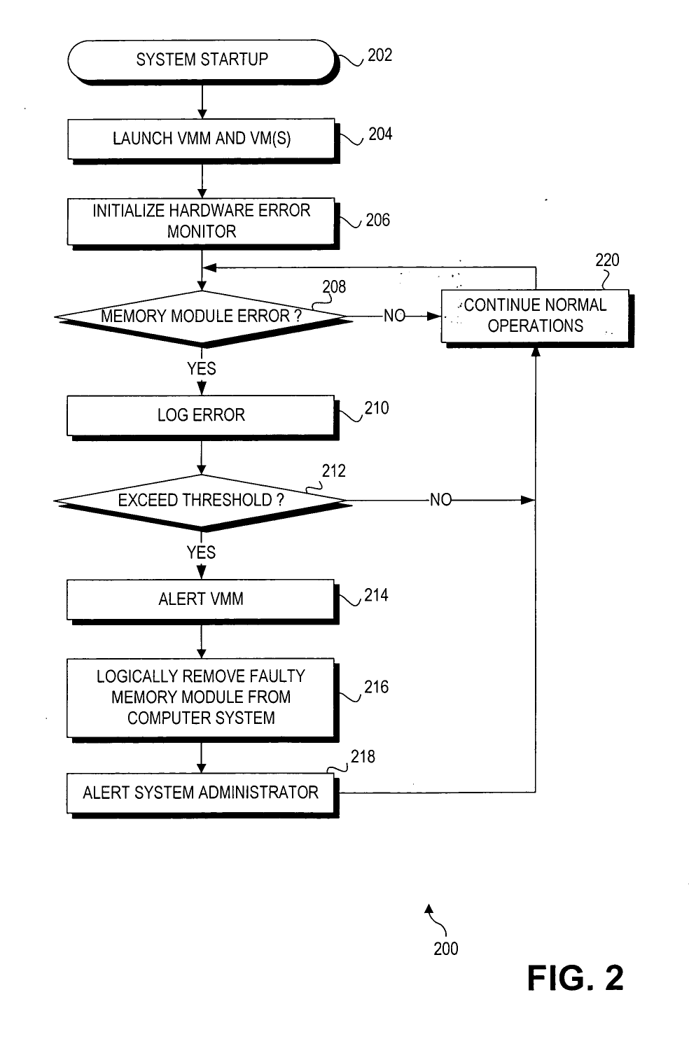

Referring to FIG. 2, a flowchart 200 illustrating the logic and operations of an embodiment of the invention is shown. In one embodiment, operations described in flowchart 200 may be conducted substantially by instructions executing on processor 110. In one embodiment, these instructions are part of firmware instructions 115. While flowchart 200 will be described in conjunction with FIG. 1, it will be understood that embodiments of flowchart 200 are not limited to implementations on computer system 100.

Starting in a block 202, computer system 100 is started up/reset. In one embodiment, instructions stored in non-volatile storage, such as Flash memory 114, are loaded and executed.

Continuing to a block 204, VMM 106 and one or more VMs are launched on computer system 100. In one embodiment, the VMM is loaded from a local storage device, such as Flash memory 114. In another embodiment, the VMM is loaded across a network connection from another computer system. In one embodiment, a VM is a “container” launched by the VMM to hold a targeted software payload, such as a Guest OS.

Proceeding to a block 206, hardware error monitor 109 is initialized. Hardware error monitor 109 may track memory errors and alert VMM 106 when action needs to be taken in response to memory errors. Initializing hardware error monitor 109 may include loading one or more thresholds associated with memory errors and loading VMM reserved memory module policy (discussed below).

A memory error may include a Single Bit Error (SBE) or a multi-bit error (MBE). In one embodiment, a threshold includes an error count per time frame. For example, a threshold may be exceeded when ‘X’ SBEs occur per hour. Thresholds may be based on SBEs, MBEs, combination of SBEs and MBEs, or other memory error types.

The thresholds may be setup according to platform policy. For example, a server storing vital company data may have stricter memory error thresholds than a desktop system. Further, thresholds may be adjusted by a system administrator.

Also, thresholds may be setup for particular memory modules or groups of memory modules. For example, a threshold for an error in memory module 112A may be different than the threshold for the same error type in memory module 112B.

In one embodiment, hardware error monitor 109 is a module of VMM 106. In another embodiment, hardware error monitor 109 is executed in a VM, such as VM 101. If a memory error is detected by a VM executed hardware error monitor, then the hardware error monitor may send an alert to VMM 106. In one embodiment, a VM executed hardware error monitor detects memory module errors within the memory scope of that VM which may be a subset of the entire system memory.

An embodiment of executing the hardware error monitor 109 in VM 101 is a Microsoft Windows® Hardware Error Architecture (WHEA). WHEA is a Windows kernel infrastructure that allows for extensible error collection and remediation plug-ins.

After block 206, the logic continues to a decision block 208 to determine if a memory error has occurred. If the answer is no, then the logic proceeds to a block 220 to continue normal operations of the computer system. After block 220, the logic returns back to decision block 208.

If the answer to decision block 208 is yes, then the logic continues to a block 210 to log the memory error. The memory error may be logged by date, time, memory module, error type (for example, SBE or MBE), or other characteristics. In one embodiment, hardware error monitor 109 manages the error log.

The error log may be maintained in local storage, such as mass storage 116, or transmitted to an external repository. The error log may be transmitted at the occurrence of each memory module error or periodically in a batch process. The error logging enables memory errors to be tracked on a per memory module basis for future analysis.

After block 210, the logic proceeds to a decision block 212 to determine if the memory module error exceeded a threshold of the hardware error monitor. If the answer to decision block 212 is no, the logic proceeds to block 220 to continue normal operations. If the answer to decision block 212 is yes, then the logic proceeds to a block 214.

In block 214, VMM 106 is alerted by hardware error monitor 109 in response to the threshold being exceeded. The alert indicates that a particular memory module has exceeded at least one threshold and this “faulty” memory module is to be logically removed from the system.

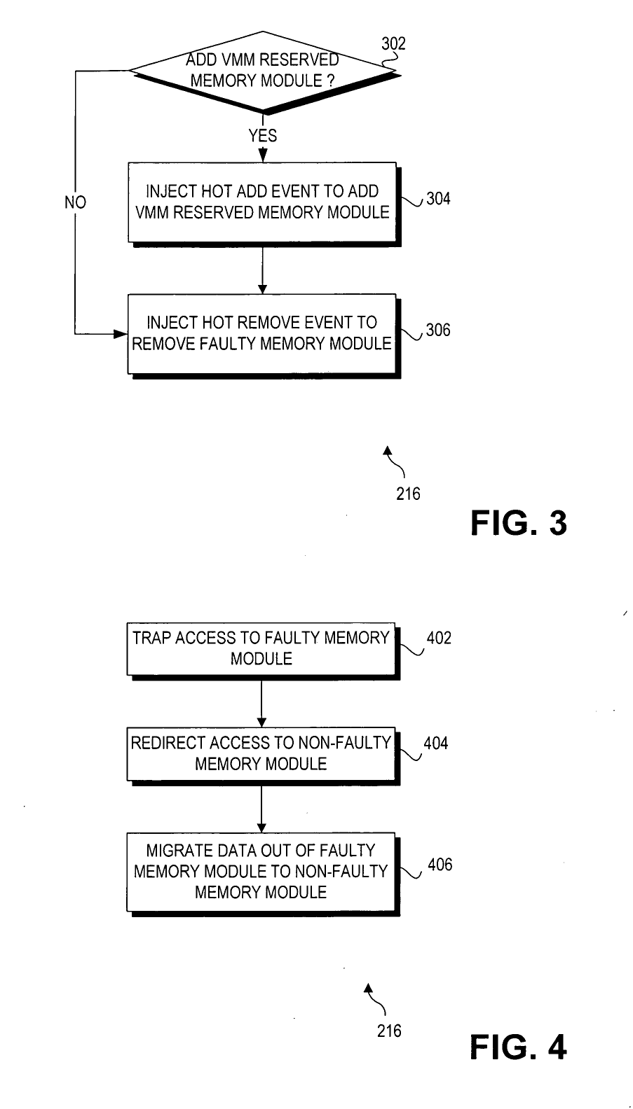

Continuing to a block 216, the faulty memory module is logically removed from the computer system. In one embodiment, the logical removal of the memory module is initiated by and/or conducted by VMM 106. The memory module will still physically reside in its slot, but the faulty memory module will no longer be used. Further, data currently stored in the faulty memory module is migrated to other memory modules. Embodiments of logically removing the faulty memory module will be discussed below in conjunction with FIGS. 3 and 4. In one embodiment, the faulty memory module is logically removed automatically without rebooting computer system 100.

The logic continues to a block 218 to alert a system administrator. The alert may take the form of an automated email, a mark in a log, an alarm at a system administrator control center, or the like. After block 218, the logic proceeds to block 220 to continue normal operations.

Embodiments herein may take corrective action without the need for human intervention. After the system administrator receives the alert, a technician may be dispatched to research the memory problem and perhaps replace the faulty memory module. However, the automated handling of memory errors allows the computer system to stay “up” despite a faulty memory module. The fault memory module may be investigated by a technician during normal maintenance rounds instead of creating an emergency situation. Embodiments herein promote reliability, availability, and serviceability (RAS) of memory and enable a platform to achieve mission critical requirements such as 5 9's (99.999%) “up” time.

Turning to FIG. 3, an embodiment of block 216 to logically remove a faulty memory module is shown. Starting in a decision block 302, the logic determines if a VMM reserved memory module is to be added to the system.

A VMM reserved memory module is a memory module of the system that is held back by the VMM and not allocated to the VMs. The VMs (and respective Guest OSs) are typically allocated some portion of physical memory and do not have real access to the physical memory. Thus, the VMs are not aware of the availability of the VMM reserved memory module. The hot add event notifies the VMs (and their respective Guest OSs) that a new memory module is now available for their use.

For example, in FIG. 1, memory modules 112A-C may be initially reported to the VMs, but 112D may be kept as a VMM reserved memory module. If memory module 112A is later determined to be faulty, then memory module 112D may be added to the system. In alternative embodiments, there may be two or more VMM reserved memory modules.

In one embodiment, the determination to add a VMM reserved memory module may be based on platform policy. For example, a VMM reserved memory module may not even be available because platform policy dictated that a VMM reserved memory module not be held back at startup. In another example, the logic may determine how much of the current memory is being used and if removing the faulty memory module without adding a VMM reserved memory module will impact system performance. If the answer to decision block 302 is yes, then the logic proceeds to block 304. If the answer is no, the logic proceeds to a block 306.

In block 304, a hot add event is injected into the system by VMM 106 to add a VMM reserved memory module. In one embodiment, a hot plug driver in each Guest OS, such as hot plug drivers 120 and 121, are invoked to enable hot adding of the VMM reserved memory module. In other embodiments, more than one VMM reserved memory module may be added to the system at a time. After block 304, the logic proceeds to block 306.

In block 306, a hot remove event is injected into the system by VMM 106 to remove the faulty memory module. The hot remove event notifies the Guests OSs that the faulty memory module is about to be removed and the Guests OSs should remap data out of the faulty memory module prior to removal.

In one embodiment, a hot plug driver in each Guest OS, such as hot plug drivers 120 and 121, are invoked to support hot removal. The hot plug drivers may “broadcast” to their respective Guest OSs that the faulty memory module is about to be removed so “listeners” may determine if any action needs to be taken. In one embodiment, the faulty memory module is identified by virtual memory addresses correlating to the faulty memory module.

Listeners may include applications executing on the OS, OS drivers, or the like. These listeners may report that they have data to be moved out of the faulty memory module. The hot plug driver or other OS components take appropriate action to migrate data out of the faulty memory module and report new virtual memory addresses to the listeners or remap the data to new physical memory that now back the previously assigned virtual memory addresses.

In one embodiment, the hot add event and the hot remove event are substantially in compliance with an Advanced Configuration and Power Interface (ACPI) Specification (version 2.0b, Oct. 11, 2002). ACPI is an industry-standard interface for OS-directed configuration and power management of computer systems, such as laptops, desktops, and servers.

ACPI provides mechanisms for handling hot insertion and hot removal of devices. ACPI supports a software-controlled, VCR (videocassette recorder) style ejection mechanism. Under the VCR-style, the “eject” button for a device does not immediately remove the device, but simply signals the OS. The OS (via Operating System directed-configuration and Power Management (OSPM)) shuts down the device, closes open files, unloads the device driver, and sends a command to the hardware to eject the device.

ACPI hot removal may be performed using a _Ejx control method. This method may be used with devices that require an action, such as isolation of power or data lines, before the device can be removed from the system. The _Ejx method supports removal when the system is hot (state S0), as well as during various sleep states (for example, states S1-S4). The ‘x’ of _Ejx indicates the control method for a particular state ‘x’.

Referring to FIG. 4, another embodiment of block 216 to logically remove the faulty memory module is shown. Starting in a block 402, accesses to a faulty memory module are trapped by VMM 106. As used herein, a memory access may include a read or a write. Continuing to a block 404, VMM 106 may redirect the access to one or more non-faulty memory modules. Since VMM 106 has ultimate control of the physical hardware, VMM 106 may steer accesses away from the faulty memory module.

Proceeding to a block 406, data in a faulty memory module is migrated out of the faulty memory module and into the one or more non-faulty memory modules. In one embodiment, when data is requested that has already been stored in the now determined faulty memory module, the data may be remapped to a non-faulty memory module. Thus, future accesses to the data will be made to a non-faulty memory module. In an alternative embodiment, VMM 106 may migrate all data out of the faulty memory module at one time in response to the VMM alert of block 214.

It will be appreciated that the embodiment of FIG. 4 is OS independent. A Guest OS does not have to perform any hot add or hot remove related activity. The embodiment of FIG. 4 may be used when a Guest OS does not support ACPI for hot add and hot remove. This embodiment may also be used when a Guest OS does not have an appropriate hot plug driver.

Embodiments herein provide increased reliability of memory. As the density of memory modules has increased, the number of SBEs and MBEs has increased. Denser circuitry is more susceptible to stray “cosmic rays” and other spurious electromagnetic effects. Also, the power requirements of high density memory modules results in increased heating and consequently thermal-related memory module errors. If a platform includes numerous memory modules packed together, then this heating problem is magnified.

Embodiments herein provide for memory errors to be tracked and corrected on a per memory module basis. Also, platform policy for handling memory errors may be specified and modified on a per memory module basis. Further, corrective action may occur without human intervention and without rebooting the system.

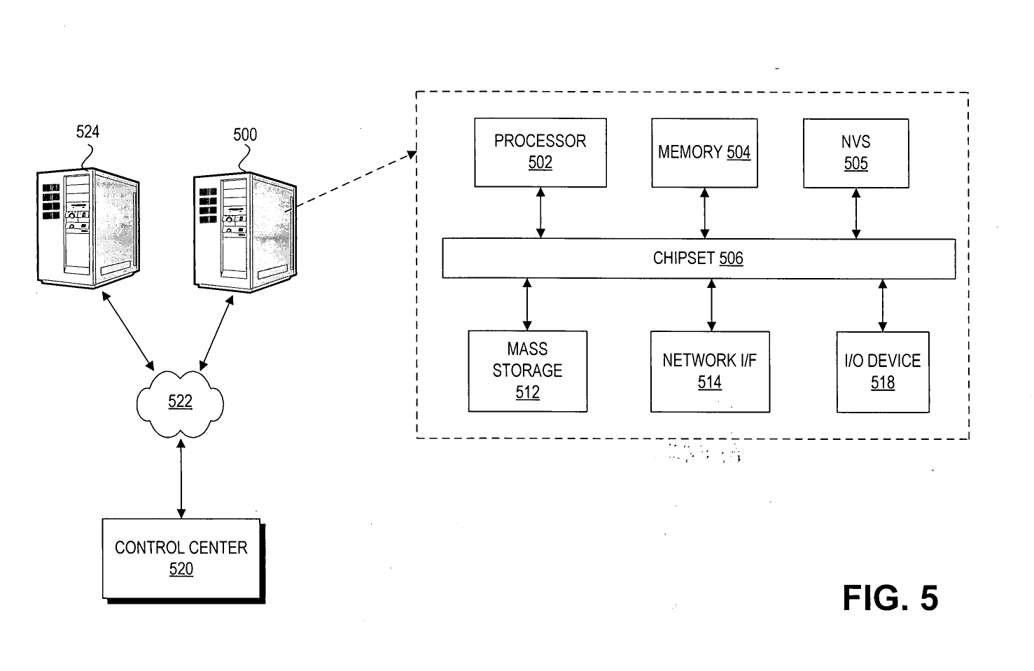

FIG. 5 is an illustration of one embodiment of a computer system 500 on which embodiments of the present invention may be implemented. Computer system 500 includes a processor 502 and a memory 504 coupled to a chipset 506. Mass storage 512, Non-Volatile Storage (NVS) 505, network interface (I/F) 514, and Input/Output (I/O) device 518 may also be coupled to chipset 506. Embodiments of computer system 500 include, but are not limited to, a desktop computer, a notebook computer, a server, a personal digital assistant, a network workstation, or the like. In one embodiment, computer system 500 includes processor 502 coupled to memory 504, processor 502 to execute instructions stored in memory 504.

Computer system 500 may connect to a network 522. A computer system 524 may also connect to network 522. In one embodiment, computer systems 500 and 524 may include servers of an enterprise network managed by a system administrator at a control center 520.

Platform policy regarding memory, such as memory error thresholds and VMM reserved memory module policy, may be managed from control center 520. Alerts as described herein may be sent to control center 520 from systems 500 and 524.

Embodiments of computer system 500 are described as follows. Processor 502 may include, but is not limited to, an Intel® Corporation Pentium®, Xeon®, or Itanium® family processor, or the like. In one embodiment, computer system 600 may include multiple processors. In another embodiment, processor 602 may include two or more processor cores.

Memory 504 may include, but is not limited to, Dynamic Random Access Memory (DRAM), Static Random Access Memory (SRAM), Synchronized Dynamic Random Access Memory (SDRAM), Rambus™ Dynamic Random Access Memory (RDRAM), or the like. In one embodiment, memory 504 may include one or more memory units that do not have to be refreshed.

Chipset 506 may include a memory controller, such as a Memory Controller Hub (MCH), an input/output controller, such as an Input/Output Controller Hub (ICH), or the like. In an alternative embodiment, a memory controller for memory 504 may reside in the same chip as processor 502. Chipset 506 may also include system clock support, power management support, audio support, graphics support, or the like. In one embodiment, chipset 506 is coupled to a board that includes sockets for processor 502 and memory 504.

Components of computer system 500 may be connected by various interconnects. In one embodiment, an interconnect may be point-to-point between two components, while in other embodiments, an interconnect may connect more than two components. Such interconnects may include a Peripheral Component Interconnect (PCI), such as PCI Express, a System Management bus (SMBUS), a Low Pin Count (LPC) bus, a Serial Peripheral Interface (SPI) bus, an Accelerated Graphics Port (AGP) interface, or the like. I/O device 518 may include a keyboard, a mouse, a display, a printer, a scanner, or the like.

Computer system 500 may interface to external systems through network interface 514. Network interface 514 may include, but is not limited to, a modem, a Network Interface Card (NIC), or other interfaces for coupling a computer system to other computer systems. A carrier wave signal may be received/transmitted by network interface 514 to connect computer system 500 with network 522.

Computer system 500 also includes non-volatile storage 505 on which firmware may be stored. Non-volatile storage devices include, but are not limited to, Read-Only Memory (ROM), Flash memory, Erasable Programmable Read Only Memory (EPROM), Electronically Erasable Programmable Read Only Memory (EEPROM), Non-Volatile Random Access Memory (NVRAM), or the like.

Mass storage 512 includes, but is not limited to, a magnetic disk drive, such as a hard disk drive, a magnetic tape drive, an optical disk drive, or the like. It is appreciated that instructions executable by processor 502 may reside in mass storage 512, memory 504, non-volatile storage 505, or may be transmitted or received via network interface 514.

In one embodiment, computer system 500 may execute an Operating System (OS). Embodiments of an OS include Microsoft Windows®, the Apple Macintosh operating system, the Linux operating system, the Unix operating system, or the like.

In one embodiment, computer system 500 employs the Intel® Virtualization Technology (VT). VT may provide hardware support to facilitate the separation of VMs and the transitions between VMs and the VMM.

For the purposes of the specification, a machine-accessible medium includes any mechanism that provides (i.e., stores and/or transmits) information in a form readable or accessible by a machine (e.g., a computer, network device, personal digital assistant, manufacturing tool, any device with a set of one or more processors, etc.). For example, a machine-accessible medium includes, but is not limited to, recordable/non-recordable media (e.g., Read-Only Memory (ROM), Random Access Memory (RAM), magnetic disk storage media, optical storage media, a flash memory device, etc.). In addition, a machine-accessible medium may include propagated signals such as electrical, optical, acoustical or other forms of propagated signals (e.g., carrier waves, infrared signals, digital signals, etc.).

Various operations of embodiments of the present invention are described herein. These operations may be implemented by a machine using a processor, an Application Specific Integrated Circuit (ASIC), a Field Programmable Gate Array (FPGA), or the like. In one embodiment, one or more of the operations described may constitute instructions stored on a machine-accessible medium, that when executed by a machine will cause the machine to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment of the invention.

The above description of illustrated embodiments of the invention, including what is described in the Abstract, is not intended to be exhaustive or to limit the embodiments to the precise forms disclosed. While specific embodiments of, and examples for, the invention are described herein for illustrative purposes, various equivalent modifications are possible, as those skilled in the relevant art will recognize. These modifications can be made to embodiments of the invention in light of the above detailed description. The terms used in the following claims should not be construed to limit the invention to the specific embodiments disclosed in the specification. Rather, the following claims are to be construed in accordance with established doctrines of claim interpretation.

What is claimed is:

1. A method, comprising:
initializing a hardware error monitor of a computer system;
detecting a memory module error in a memory module of the computer system by the hardware error monitor; and
logically removing the memory module from the computer system in response to the memory module error.

2. The method of claim 1, further comprising logging the memory module error.

3. The method of claim 1 wherein the memory module is logically removed when the memory module error results in a threshold of the hardware error monitor being exceeded.

4. The method of claim 1, further comprising:
launching a Virtual Machine Monitor (VMM) on the computer system; and
launching a Virtual Machine (VM) on the computer system supported by the VMM.

5. The method of claim 4 wherein logically removing the memory module includes injecting a hot remove event by the VMM to initiate hot removing of the memory module.

6. The method of claim 5 wherein logically removing the memory module includes injecting a hot add event by the VMM to initiate hot adding of a VMM reserved memory module, wherein the VMM reserved memory module is not available to the VM prior to the injecting of the hot add event.

7. The method of claim 4 wherein logically removing the memory module includes:
trapping an access to the memory module by the VMM;
redirecting the access to one or more non-faulty memory modules of the computer system by the VMM; and
migrating data out the memory module to the one or more non-faulty memory modules.

8. The method of claim 4 wherein the VMM includes the hardware error monitor.

9. The method of claim 4 wherein the hardware error monitor is executed in the VM.

10. The method of claim 1, further comprising alerting a system administrator in response to the memory module error.

11. An article of manufacture, comprising:
a machine-accessible medium including instructions that, if executed by a machine, will cause the machine to perform operations comprising:
launching a Virtual Machine Monitor (VMM) on a computer system;
launching a Virtual Machine (VM) supported by the VMM; and
logically removing a memory module from the computer system in response to a memory module error detected in the memory module by the VMM.

12. The article of manufacture of claim 11 wherein the machine-accessible medium further includes instructions that, if executed by the machine, will cause the machine to perform operations comprising:
logging the memory module error.

13. The article of manufacture of claim 11 wherein the memory module is logically removed in response to the memory module error exceeding a memory module error threshold.

14. The article of manufacture of claim 11 wherein logically removing the memory module includes:
injecting an Advanced Configuration and Power Interface (ACPI) hot add event by the VMM to hot add a VMM reserved memory module, wherein the VMM reserved memory module is not available to the VM prior to the injecting of the ACPI hot add event; and
injecting an ACPI hot remove event by the VMM to hot remove the memory module.

15. The article of manufacture of claim 11 wherein logically removing the memory module includes:
trapping an access to the memory module by the VMM;
redirecting the access to one or more non-faulty memory modules of the computer system by the VMM; and
migrating data out the memory module to the one or more non-faulty memory modules.

16. The article of manufacture of claim 11 wherein the memory module error is detected by a hardware error monitor of the VMM.

17. The article of manufacture of claim 11 wherein the machine-accessible medium further includes instructions that, if executed by the machine, will cause the machine to perform operations comprising:
initiating an alert to be sent to a system administrator in response to the memory module error.

18. A computer system, comprising:
a processor;
a Dynamic Random Access Memory (DRAM) memory module coupled to the processor; and
a storage unit coupled to the processor, wherein the storage unit including instructions that, if executed by the processor, will cause the processor to perform operations comprising:
launching a Virtual Machine Monitor (VMM) on the computer system; and
launching a Virtual Machine (VM) supported by the VMM; and
logically removing the DRAM memory module from the computer system in response to a memory module error detected in the DRAM memory module by the VMM.

19. The computer system of claim 18 wherein the storage unit further includes instructions that, if executed by the processor, will cause the processor to perform operations comprising:
injecting an Advanced Configuration and Power Interface (ACPI) hot add event by the VMM to hot add a VMM reserved memory module, wherein the VMM reserved memory module is not available to the VM prior to the injecting of the ACPI hot add event; and
injecting an ACPI hot remove event by the VMM to hot remove the DRAM memory module.

20. The computer system of claim 18 wherein the processor to operate substantially in compliance with an Intel® Virtualization Technology.
